(19) United States
(12) Patent Application Publication
(10) Pub. No.: US 2006/0251041 A1
(43) Pub. Date: Nov. 9, 2006

(54) Radio resource allocation in telecommunication system

(76) Inventors: Kari Pajukoski, Oulu (FI); Esa Tiirola, Oulu (FI); Kari Horneman, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/362,706

(22) Filed: Feb. 28, 2006

(30) Foreign Application Priority Data
May 6, 2005 (FI) 20055211
Aug. 16, 2005 (FI) 20055437

(51) Int. Cl. H04J 1/00

(52) U.S. Cl. 370/343; 370/401

(57) ABSTRACT

A solution for radio resource allocation in a cellular telecommunication system is provided. According to the invention, the frequency bands of a plurality of cells of the telecommunication system are divided independently into more than one frequency band sub-block. User terminals within the coverage area of each cell are then allocated to the frequency band sub-blocks on the basis of the modulation and coding schemes used by the user terminals. Furthermore, transmission power of the user terminals is controlled on the basis of the allocation of the user terminals in order to improve data throughput.

### FIELD

The invention relates to radio resource allocation in a cellular telecommunication system.

### BACKGROUND

Frequency Division Multiple Access (FDMA) technology is widely used in wireless communication systems. FDMA refers to a wireless communication technique in which a frequency spectrum is divided into a plurality of smaller frequency components. Each component of the spectrum has a carrier signal that can be modulated with data. This increases the amount of data that can be communicated over the spectrum, and also provides a mechanism for allocating a bandwidth to service providers.

For example, in the upcoming evolution of 3GPP (3^{rd} Generation Partnership Project) systems, FDMA offers a promising technology for increasing the throughput performance of a 3.9G uplink (UL). In an isolated cell, the gain of FDMA over WCDMA is evident. In non-isolated cells, the gain is slightly smaller and depends mainly on the required coverage area probability. An FDMA Uplink can be realized either by using single carrier FDMA (SC-FDMA) or multicarrier OFDMA (Orthogonal FDMA, OFDMA) techniques.

The performance of the uplink of FDMA and OFDMA is sensitive to non-idealities, such as a frequency error and phase noise. Generally, the frequency error is caused by Doppler shift and frequency synchronization errors between uplink and downlink transceivers. In the worst case, the frequency error caused by the Doppler Effect detected by a base station receiver is two times the maximum Doppler shift.

The problem related to the frequency error is severe in the uplink direction where each terminal has its own local oscillator synchronized with the base station's local oscillator in a downlink direction. In the synchronizing phase, each terminal sees a different Doppler shift, which is added to the frequency difference between the local oscillators of the terminal and base station. Thus, the base station sees different frequency corrections from different terminals.

The non-idealities produce adjacent channel leakage. This, in turn, causes multiple access interference, which means that different users of the FDMA/OFDMA system start to interfere each other at the base station receiver. The higher the power differences between the received levels of different users using the adjacent bands, the greater the problem with multiple access interference.

FIG. 1 illustrates the bandwidth usage principle in a known single carrier FDMA system (SC-FDMA). A common frequency band is available to multiple user terminals. The total bandwidth 110 is, for example, 20 MHz. Each user terminal adjusts the carrier frequency and signal bandwidth 100, 102, 104, for example, according to the data rate and signal-to-interference-noise-ratio (SINR). In the SC-FDMA, the problem of multiple access interference is solved by transmit and receive filters and guard bands 106, 108 between the users. The drawback of SC-FDMA is that rather broad guard bands and long guard times are needed, which causes a high overhead. This, in turn, will decrease the spectrum efficiency of the system. The problem is greatest with the narrowest transmission bandwidths.

FIG. 2 illustrates another known way of spectrum utilization in FDMA/OFDMA systems. Users having different modulation and coding schemes (MCS), e.g. 16QAM⅔ USERs, QPSK½ USERs, QPSK⅙ USERs have been located in the frequency domain such that users having the same MCSs are close to each other and the users having different MCS are far away in the same frequency domain 100. In the receiver side a common filter is used. The problem with this approach is that the users having high received power levels (e.g. 16 QAM, effective code rate (ECR)=⅔) cause strong interference to other users having low received power levels. The interference problem is more severe if there are frequency errors in the system.

Because of the foregoing reasons it is desirable to consider improvements to radio resource control in the uplink of cellular telecommunication systems in order to control multiple access interference.

### BRIEF DESCRIPTION OF THE INVENTION

An object of the invention is to provide an improved radio resource allocation method in a cellular telecommunication system, an improved network element of a cellular telecommunication system providing user terminals with communications within the coverage area of the cellular telecommunication system, an improved cellular telecommunication system, an improved computer program product encoding a computer program of instructions for executing a computer process for radio resource allocation in a cellular telecommunication system, and an improved computer program distribution medium.

According to an aspect of the invention, there is provided a radio resource allocation method in a cellular telecommunication system, the method comprising dividing the frequency band of a plurality of cells of the cellular telecommunication system independently into more than one frequency band subblock, allocating user terminals within the coverage area of each cell to the frequency band sub-blocks on the basis of the modulation and coding schemes used by the user terminals, and controlling transmission power of the user terminals on the basis of the allocation of the user terminals.

According to another aspect of the invention, there is provided a network element of a cellular telecommunication system providing user terminals with communications within the coverage area of the cellular telecommunication system, the coverage area being divided into a plurality of cells. The network element comprises a processing unit configured to divide the frequency band of a plurality of cells of the cellular telecommunication system independently into more than one frequency band sub-block, allocate user terminals within the coverage area of each cell to frequency band sub-blocks on the basis of the modulation and coding schemes used by the user terminals, and control transmission power of the user terminals on the basis of the allocation of the user terminals.

According to another aspect of the invention, there is provided a cellular telecommunication system comprising a network infrastructure providing communications within the coverage area of the cellular telecommunication system with the coverage area being divided into a plurality of cells, and a plurality of user terminals located within the coverage area of the cellular telecommunication system. The network infrastructure comprises a processing unit configured to divide the frequency band of a plurality of cells of the cellular telecommunication system independently into more than one frequency band sub-block, allocate user terminals within the coverage area of each cell to frequency band sub-blocks on the basis of the modulation and coding schemes used by the user terminals and to control transmission power of the user terminals on the basis of the allocation of the user terminals.

According to another aspect of the invention, there is provided a computer program product encoding a computer program of instructions for executing a computer process for radio resource allocation in a cellular telecommunication system. The process comprises dividing the frequency band of a plurality of cells of the telecommunication system independently into more than one frequency band sub-block, allocating user terminals within the coverage area of each cell to frequency band sub-blocks on the basis of the modulation and coding schemes used by the user terminals, and controlling transmission power of the user terminals on the basis of the allocation of the user terminals.

According to another aspect of the invention, there is provided a computer program distribution medium readable by a computer and encoding a computer program of instructions for executing a computer process for radio resource allocation in a cellular telecommunication system. The process comprises dividing the frequency band of a plurality of cells of the telecommunication system independently into more than one frequency band sub-block, allocating user terminals within the coverage area of each cell to frequency band sub-blocks on the basis of the modulation and coding schemes used by the user terminals, and controlling transmission power of the user terminals on the basis of the allocation of the user terminals.

The invention provides several advantages. The invention provides improved control of multiple access interference through effective radio resource allocation in a cellular telecommunication system. As a result, data throughput of the cellular telecommunication system is increased. The invention also provides improved mitigation of the near-far effect through effective radio resource allocation in the cellular telecommunication system. Additionally, the invention may be used in the cells of the cellular telecommunication system independently without any coordination between the cells.

### LIST OF DRAWINGS

In the following, the invention will be described in greater detail with reference to the embodiments and the accompanying drawings, in which

FIG. 1 illustrates an example of the bandwidth usage principle in a known single carrier FDMA system;

FIG. 2 illustrates another known way of spectrum utilization in known FDMA/OFDMA systems;

FIG. 3 shows an example of a wireless cellular telecommunications system according to an embodiment of the invention;

FIG. 4 shows another example of a wireless cellular telecommunications system according to an embodiment of the invention;

FIG. 5A illustrates an example of the method of controlling radio resources in a cellular telecommunication system according to an embodiment of the invention;

FIG. 5B illustrates an example of the method of controlling radio resources in a plurality of cells of a cellular telecommunication system according to an embodiment of the invention;

FIG. 6 illustrates another example of the method of controlling radio resources in a cellular telecommunication system according to an embodiment of the invention; and

FIG. 7 illustrates another example of the method of controlling radio resources in a cellular telecommunication system according to an embodiment of the invention.

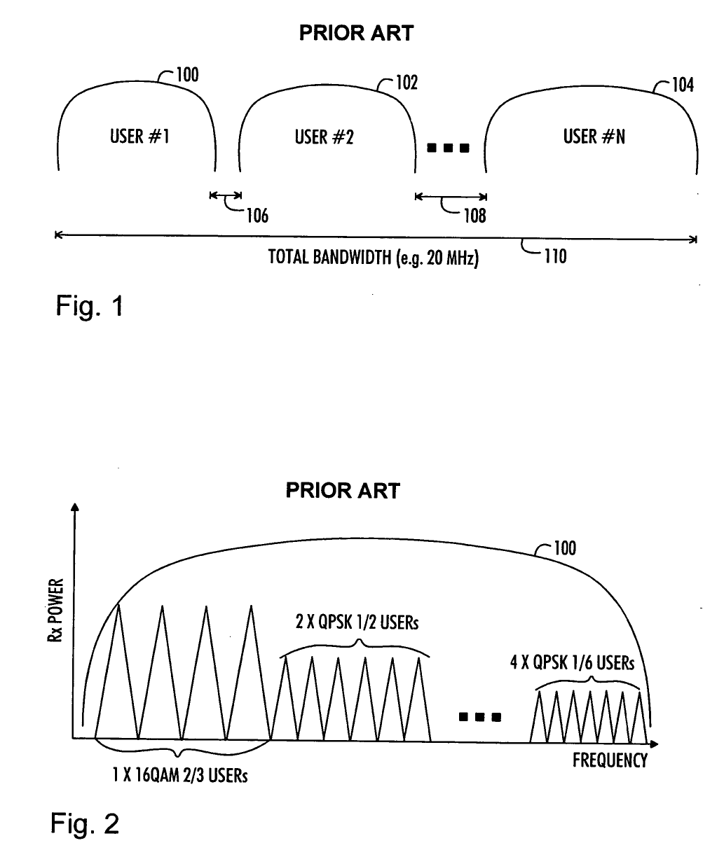

### DESCRIPTION OF EMBODIMENTS

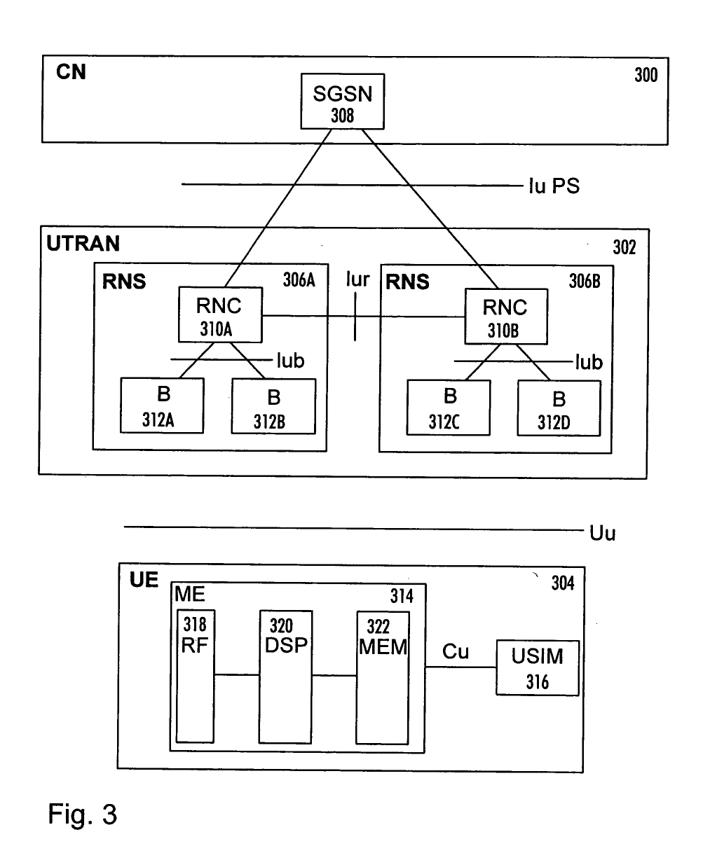

FIG. 3 illustrates an example of a wireless cellular telecommunications system to which the present solution may be applied. Below, embodiments of the invention will be described using the UMTS (Universal Mobile Telecommunications System) as an example of the cellular telecommunications system. The invention may, however, be applied to other cellular telecommunication systems. The structure and functions of such a cellular telecommunications system and those of the associated network elements are only described when relevant to the invention.

The cellular telecommunications system may be divided into a core network (CN) 300, a UMTS terrestrial radio access network (UTRAN) 302, and a user terminal (UE) 304. The core network 300 and the UTRAN 302 compose a network infrastructure of the wireless telecommunications system.

The UTRAN 302 is typically implemented with wideband code division multiple access (WCDMA) radio access technology.

The core network 300 includes a serving GPRS support node (SGSN) 308 connected to the UTRAN 302 over an lu PS interface. The SGSN 308 represents the center point of the packet-switched domain of the core network 100. The main task of the SGSN 308 is to transmit packets to the user terminal 304 and to receive packets from the user terminal 304 by using the UTRAN 302. The SGSN 308 may contain subscriber and location information related to the user terminal 304.

The UTRAN 302 includes radio network sub-systems (RNS) 306A, 306B, each of which includes at least one radio network controller (RNC) 310A, 310B and nodes B (or base stations) 312A, 312B, 312C, 312D.

Some functions of the radio network controller 310A, 310B may be implemented with a digital signal processor, memory, and computer programs for executing computer processes. The basic structure and operation of the radio network controller 310A, 310B are known to one skilled in the art and only the details relevant to the present solution are discussed in detail.

The node B 312A, 312B, 312C, 312D implements the Uu interface, through which the user terminal 304 may access the network infrastructure. Each node B 312A, 312B, 312C, 312D typically provides a communication link between the network infrastructure and user terminals within a determined coverage area known as a cell. The cell may be further divided into sectors. Some functions of the base station 312A, 312B, 312C, 312D may be implemented with a digital signal processor, memory, and computer programs for executing computer processes. The basic structure and operation of the base station 312A, 312B, 312C, and 312D are known to one skilled in the art and only the details relevant to the present solution are discussed in detail.

The user terminal 304 may include two parts: mobile equipment (ME) 314 and a UMTS subscriber identity module (USIM) 316. The mobile equipment 314 typically includes radio frequency parts (RF) 318 for providing the Uu interface. The user terminal 304 further includes a digital signal processor 320, memory 322, and computer programs for executing computer processes. The user terminal 304 may further comprise an antenna, a user interface, and a battery not shown in FIG. 3. The USIM 316 comprises user-related information and information related to information security in particular, for instance, an encryption algorithm.

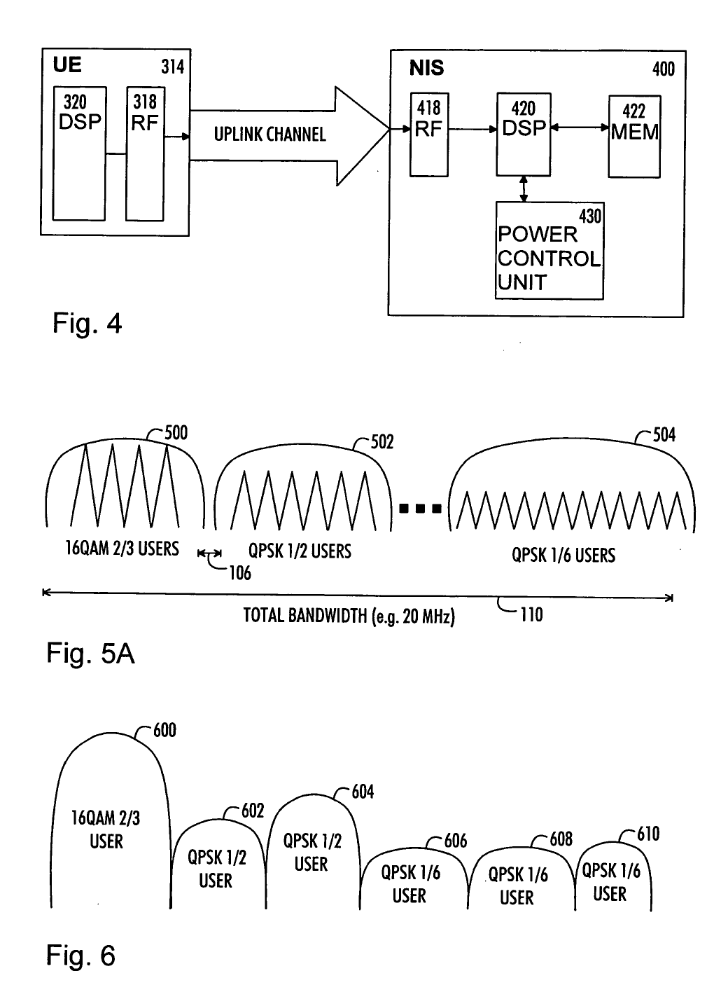

FIG. 4 shows another example of a wireless telecommunications system. The wireless telecommunications system comprises a network infrastructure (NIS) 400 and a user terminal (UE) 314. The user terminal 314 may be connected to the network infrastructure 400 over an uplink physical data channel, such as a DPDCH (Dedicated Physical Data channel) defined in the 3GPP specification.

An uplink control channel, such as an uplink DPCCH (Dedicated Physical Control Channel) defined in the 3GPP (3^{rd} Generation Partnership Project) specification, transmitted by the user terminal 314 includes pilot sequences. The network infrastructure 400 decodes the pilot sequences and estimates signal quality parameters, such as the power level of the received signal and SIR (Signal-to-Interference Ratio), of the uplink DPCCH.

The network infrastructure 400 generates power control commands on the basis of the signal quality parameters and transmits the power control commands to the user terminal 314 over a downlink control channel, such as a downlink DPCCH. The power control commands may be associated with an inner loop of a closed-loop power control protocol, for example. The network infrastructure may set a target value for SIR of a signal received from a given user terminal and control the transmission power of the user terminal in order to achieve the target SIR.

The network infrastructure 400 comprises a transmitting/receiving unit 418, which carries out channel encoding of transmission signals, converts them from the baseband to the transmission frequency band and modulates and amplifies the transmission signals. The signal processing unit DSP 420 controls the operation of the network element and evaluates signals received via the transmitting/receiving unit 418. Data about the transmission and switching times and specific characteristics of the connections are stored in a memory 422.

In FIG. 4, only one user terminal 314 is shown. However, it is assumed that there are several user terminals 314 that share a common frequency band for communicating with the network infrastructure 400. The user terminals 314 may be scattered throughout the coverage area of the network infrastructure 400, which may be divided into cells with each cell being associated with a Node B. The user terminals within a cell may be served by the Node B associated with the cell. If a user terminal resides at the edge of a cell, the user terminal may be served by one or more nodes B associated with adjacent cells.

The cellular telecommunication system according to an embodiment of the invention may employ several data modulation schemes in order to transfer data between user terminals 314 and network infrastructure 400 with variable data rates. The cellular telecommunication system may employ, for example, quadrature phase shift keying (QPSK) and quadrature amplitude modulation (QAM) modulation schemes. Several coding schemes may also be implemented with different effective code rates (ECR). For example, when a communication link between a user terminal 314 and network infrastructure 400 is of low quality, strong coding may be used in order to ensure reliable data transfer. On the other hand, under a high quality communication link lighter coding may be used to provide high data rate communications.

In the upcoming systems, such as in 3.9G systems, frequency division multiple access (FDMA) techniques where users are separated into different frequency bands can be used particularly for uplink communications. By employing FDMA properly for uplink communications, the interference-limited nature of the telecommunication system may be improved, if compared to the code division multiple access (CDMA) based uplink communications.

Next, allocation of user terminals 314 to frequency band sub-blocks according to embodiments of the invention will be described. In the following description, only one cell of a cellular telecommunication system is considered, but the embodiments of the invention may be advantageously used in a plurality of cells of the cellular telecommunication system in order to obtain an improved control of multiple access interference in the cellular telecommunication system.

The network infrastructure 400 measures the signals in the uplink direction. The resource request from the user terminal 314 is thus recognized, for example by a node B providing the communication services within the cell the user terminal is currently located in. The decision is made whether it is possible to allocate resources to the user terminal 314. If, for example, an adequate signal-to-noise ratio is detected, then the user terminal 314 is allocated a frequency band via an allocation channel. The resource request may be received when a user terminal 314 initiates communications with the network infrastructure or when the user terminal is moving from one cell to another and handover is considered. In the latter case, the user terminal may request radio resources from the node B of the cell in the direction of movement of the user terminal.

In an embodiment, the radio resources allocation is carried out in the network infrastructure 400, such as a network element (e.g. node B, Radio Network Controller, a server, a router unit, or an equivalent element of the cellular telecommunication network). The processing unit 420 is configured to divide the frequency band of each cell of the cellular telecommunication system independently into more than one frequency band sub-block and to allocate user terminals 314 within the coverage area of each cell to frequency band sub-blocks on the basis of the modulation and coding schemes used by the user terminals 314. The processing unit 420 is further configured to control transmission power of the user terminals 314 on the basis of the allocation of the user terminals 314.

Thus, the total frequency bandwidth is divided into several frequency band sub-blocks. For example, if the total bandwidth is 20 MHz, then the possible sizes of the sub-blocks may be multiples of the minimum block size, for example 480 KHz.

In an embodiment, the network infrastructure 400 may first detect which modulation and coding scheme a given user terminal 314 is using and then allocate the given user terminal 314 to a given frequency band sub-block on the basis of the detected modulation and coding scheme. The user terminals 314 may, for example, inform the network infrastructure 400 about which modulation and coding schemes the user terminals 314 are going to use.

In another embodiment, a given user terminal 314 may have several alternative combinations of modulation and coding schemes that the user terminal 314 may use. The user terminal 314 may then inform the network infrastructure 400 about the different combinations via a control channel, for example. The network infrastructure 400 may then choose a given combination of the modulation and coding scheme alternatives to be used in a given frequency band sub-block. The network infrastructure 400 may then inform the user terminals 314 about the selected modulation and coding schemes that are to be used in given frequency band sub-blocks.

In an embodiment, the network infrastructure 400 may inform the user terminals 314 about a given modulation and coding scheme that is going to be used in a given frequency band sub-block. Thus, the network infrastructure 400 may, in fact, force the user terminals 314 to use a given modulation and coding scheme in certain frequency band sub-blocks.

In another embodiment, the user terminals 314 may have the knowledge about which modulation and coding scheme combinations can be used in given frequency band sub-blocks. The network infrastructure 400 may have provided this information to the user terminals 314 in advance.

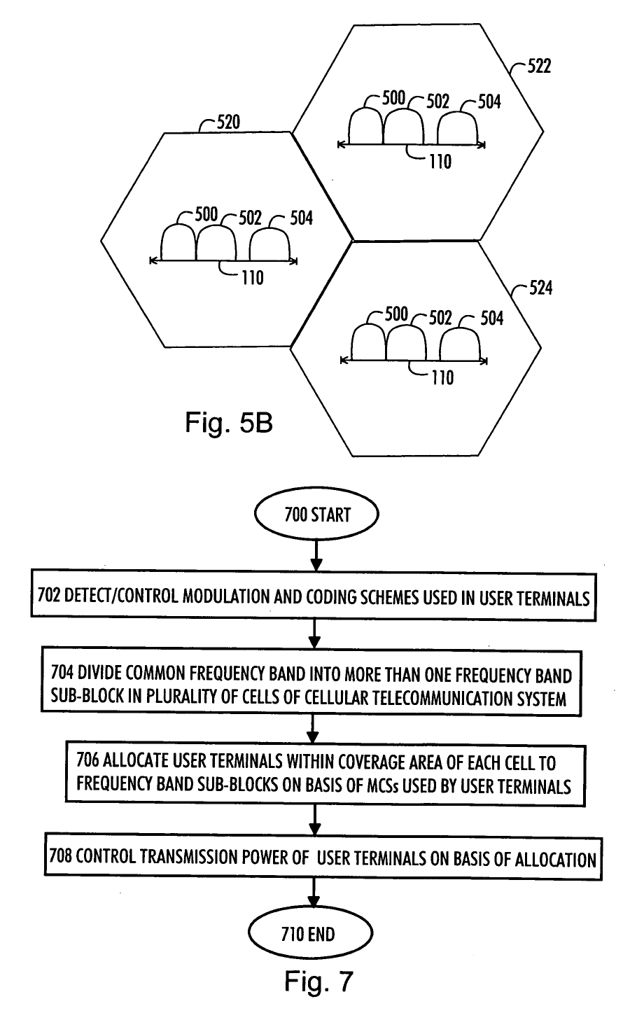

FIG. 5 illustrates the principle of an embodiment of the invention that can be utilized in FDMA-based cellular telecommunication systems where one or more user terminals are allocated to different frequency band sub-blocks 500, 502, 504. The user terminals are allocated to different sub-blocks 500, 502, 504 according to the used modulation and coding schemes (MCS). In the example of FIG. 5, users employing 16QAM modulation scheme and coding scheme with an effective code rate of ⅔ are allocated to the lowest frequency band sub-block 500, users employing QPSK modulation and a coding scheme with an effective code rate ½ are allocated the adjacent frequency band sub-block 502, and users employing QPSK-modulation and a coding scheme with an effective code rate of ⅙ are allocated to the highest frequency band sub-block 504. In FIG. 5, each peak in each frequency band sub-block represents a signal component of a user terminal. As a consequence, one or more peaks may represent signal components of a given user terminal.

The selection of the modulation and coding scheme can be based, for example, on traffic volume measurement and an achievable signal-to-interference-ratio. Therefore, the selection and radio resource allocation may be made adaptive in the sense that under low traffic and high achievable signal-to-interference-ratio conditions more frequency band sub-blocks may be allocated to user terminals with high data rate modulation and coding schemes. On the other hand, under high traffic and/or low achievable signal-to-interference-ratio conditions more frequency band sub-blocks may be allocated to user terminals with low data rate modulation and coding schemes in order to improve reliable data transfer by utilizing more robust modulation and coding schemes.

In an embodiment, the user terminals are allocated to the sub-blocks 500, 502, 504 such that the user terminals having the same or similar modulation and coding schemes are allocated to the same sub-blocks 500, 502, 504. The different sub-blocks 500, 502, 504 can be separated by using digital or analogue filters both in the transmitter and in the receiver side. The filtering mitigates interference between different sub-blocks. Because the user terminals 314 that have the same modulation and coding schemes have about the same received signal power levels in the network infrastructure 400, the interference between the user terminals 314 can be significantly reduced.

FIG. 6 illustrates another example of an embodiment of the invention that is utilized in a single carrier FDMA system where each user terminal is allocated to different sub-blocks 600, 602, 604, 606, 608, 610. In this embodiment, the user terminals are allocated to different sub-blocks 600, 602, 604, 606, 608, 610 according to the used modulation and coding schemes such that the users having the same or similar modulation and coding schemes are allocated to the adjacent sub-blocks. For example, the user terminals in sub-blocks 606-610 each use QPSK modulation and a coding scheme with a code rate of ⅙ and are thus allocated to adjacent sub-blocks 606-610. The user terminals in sub-blocks 602 and 604 use QPSK modulation and a coding scheme with a code rate of ½ and are thus also allocated to adjacent sub-blocks.

The user terminals allocated to the same sub-block may be allocated to different frequencies within the sub-block according to FDMA technique as described above in conjunction with FIG. 5. Instead of FDMA, code division multiple access (CDMA) and/or time division multiple access (TDMA) technique may be utilized within each frequency band sub-block in order to provide access to the network infrastructure for multiple user terminals allocated to the same sub-block.

In an embodiment, such is also possible that one or more user terminals are allocated to a second frequency band sub-block on the basis of the modulation and coding schemes used by the user terminals when the frequency band sub-block to which the one or more user terminals were first allocated is frequency hopped. Thus, in a frequency hopping situation, the one or more user terminals may be allocated to a second frequency band sub-block that uses modulation and coding scheme at least approximately similar to those used in the frequency band sub-block to which the one or more user terminals were first allocated. In an embodiment, in a frequency hopping situation, the modulation and coding scheme of the one or more user terminals may be changed to correspond to the modulation and coding scheme of the second frequency band sub-block before allocating the one or more user terminals to the second frequency band sub-block. Frequency hopping enables diversity and the performance of the receiver is enhanced. Further, interference over the total frequency band can be averaged.

According to an embodiment of the invention, the processing unit 420 of FIG. 4 may be further configured to allocate the user terminals 314 to frequency band sub-blocks on the basis of power levels of the signals received from the user terminals 314. The user terminals 314 with substantially similar power levels of signals received by the network infrastructure 400 may be allocated to the same frequency band sub-blocks in order to reduce multiple access interference (MAI). As known to one skilled in the art, the multiple access interference can be minimized when the average received power level of the user terminals 314 allocated to the same sub-block 500, 502, 504 is the same.

According to another embodiment of the invention, the processing unit 420 may calculate a radio channel path loss value for each user terminal 314 from the received signals and allocate the user terminals 314 into frequency band sub-blocks on the basis of calculated radio channel path loss values. The processing unit 420 may allocate the user terminals 314 with substantially equal path loss values to the same frequency band sub-blocks. In a typical environment, signals transmitted from user terminals located close to a base station experience only a small path loss and signals transmitted from user terminals distant from a base station (i.e. located at the edge of a cell) suffer from a significant path loss. Therefore, the user terminals located at the edge of the cell are likely to be allocated to the same sub-block and the user terminals located close to the base station to the same sub-block. A power control unit 430 of the network infrastructure may then set a target value for signal-to-noise-power ratio (or signal-to-interference-power ratio) to be the same for every user terminal 314 allocated to the same sub-block and control transmit powers of the user terminals 314 to achieve the target value. This approach reduces the negative effect of the “near-far” problem in which the user terminals 314 located close to the base station degrade the performance of the user terminals 314 located at the edge of the cell, since the user terminals 314 at the edge of the cell are not typically allocated to the same sub-blocks as the user terminals 314 located close to the base station. Thus, signal-to-interference-power ratios of user terminals 314 at the edge of the cell are improved, resulting in a higher quality communication between the user terminals 314 and the network infrastructure 400.

As mentioned above and illustrated in FIG. 5B, frequency band division into sub-blocks and radio resource allocation described above may be employed in a plurality of cells 520, 522, 524 of the cellular telecommunication system. The plurality of cells 520, 522, and 524 may be adjacent cells but the frequency band division and radio resource allocation may also be applied to isolated cells. The frequency band division into frequency band sub-blocks may be carried out independently for each cell, i.e. regardless of the frequency band division used in the other cells of the cellular telecommunication system. The network infrastructure may have allocated adjacent cells in the cellular telecommunication system to use the same frequency band, which means that a frequency reuse factor is 1/1. The invention is not, however, limited to this frequency reuse factor. The same type of radio resource allocation on the basis of modulation and coding schemes of the user terminals 314 and/or detected power levels or path loss values of the received signals may be utilized in adjacent cells of the cellular telecommunication system. As illustrated in FIG. 5B, the frequency band 110 division into sub-blocks 500, 502, 504 may be carried out in substantially the same manner in the plurality of cells 520, 522, 524 of the cellular telecommunication system. User terminals within the coverage area of a plurality of adjacent cells 520, 522, 524 may be allocated to the frequency band sub-blocks in a similar manner for each cell on the basis of the modulation and coding schemes used by the user terminals and/or power levels or path loss values associated with the transmitted signals of the user terminals. Thus, user terminals with substantially the same characteristics (modulation and coding and/or power levels or path loss values, for example) are usually allocated to the same or adjacent frequency band sub-blocks in the plurality of adjacent cells. Therefore, inter-cell interference between user terminals of adjacent cells 520, 522, 524 is reduced.

This provides an improved interference control in the cellular telecommunication system due to efficient radio resource allocation for user terminals 314, because the radio resource control is carried out in order to minimize multiple access interference.

Equivalently, the radio resource allocation described above may be implemented in a cell which has been divided into sectors. The number of sectors may be three, for example. In such a cell, division of the frequency band into frequency band sub-blocks and radio resource allocation may be carried out independently for each sector.

The embodiments of the invention can be used in orthogonal frequency division multiple access (OFDMA) and single carrier frequency division multiple access (SC-FDMA) systems, for example. Further, both the interleaved and the blocked type of OFDMA or SC-FDMA can be used inside the sub-blocks. When using the interleaved type of OFDMA, subcarriers of a plurality of user terminals allocated to the same sub-block are interleaved in the frequency domain without any two carriers occupying the same frequency band. When using the interleaved type of SC-FDMA, time-domain signal processing techniques are applied to a signal to be transmitted in a transmitting user terminal in order to produce a comb-shaped frequency spectrum to the signal to be transmitted. Frequency shift of the comb-shaped spectrum is carried out by applying a suitable phase rotation to the signal to be transmitted so that the spectrum of the transmitted signal will not occupy the same frequency components as a signal transmitted from another user terminal 314 allocated to the same frequency band sub-block. By applying this type of signal processing, a low peak-to-average power ratio can be achieved to the transmitted signal, which improves the efficiency of the amplifiers of the user terminals 314. The embodiments of the invention can be implemented by using radio frequency and baseband processing techniques known in the art.

With reference to FIG. 7, examples of methodology according to embodiments of the invention are shown in flow charts.

In FIG. 7, the method starts in 700. In 702, the modulation and coding schemes used in user terminals are detected or controlled. In 704, the frequency band of a plurality of cells of the telecommunication system is divided independently into more than one frequency band sub-block. In 706, user terminals within the coverage area of each cell are allocated to frequency band sub-blocks on the basis of the modulation and coding schemes used by the user terminals. In addition to the modulation and coding schemes of the user terminals, the allocation may be made on the basis of power levels or radio channel path loss values of signals received from the user terminals. In 708, the transmission power of the user terminals is controlled on the basis of the allocation of the user terminals.

The method ends in 710.

The embodiments of the invention may be realized in a network element of a network infrastructure of a cellular telecommunication system. The network element may comprise a processing unit which may be configured to perform at least some of the steps described in connection with the flowchart of FIG. 7 and in connection with FIGS. 5 and 6. The embodiments may be implemented as a computer program comprising instructions for executing a computer process for radio resource allocation in uplink of a cellular telecommunication system. The computer program may be executed in the digital signal processor 420 of the network element 400. Some process steps may be executed in the digital signal processor of the node B 312A to 312D. Some process steps may be executed, depending on the embodiment, in the digital signal processor of the radio network controller 310A, 310B. Alternatively or additionally, some process steps may be executed in other elements (such as servers, router units etc.) of the telecommunication network.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

Even though the invention has been described above with reference to examples in conjunction with the accompanying drawings, it is clear that the invention is not restricted thereto but it can be modified in several ways within the scope of the appended claims.

1. A radio resource allocation method in a cellular telecommunication system, the method comprising:
dividing a frequency band of a plurality of cells of the cellular telecommunication system independently into more than one frequency band sub-block;
allocating user terminals within a coverage area of each cell to the frequency band sub-blocks on the basis of modulation and coding schemes used by the user terminals; and
controlling transmission power of the user terminals on the basis of the allocation of the user terminals.

2. The method of claim 1, further comprising dividing the frequency band of each of the plurality of cells of the cellular telecommunication system into more than one frequency band sub-block regardless of a frequency band division used in other cells of the cellular telecommunication system.

3. The method of claim 1, further comprising allocating user terminals within a coverage area of a plurality of adjacent cells to the frequency band sub-blocks in substantially a same manner for each cell in order to allocate the user terminals with substantially same characteristics to the same or adjacent frequency band sub-blocks in the plurality of adjacent cells.

4. The method of claim 1, wherein a plurality of adjacent cells of the cellular telecommunication system uses a same frequency band.

5. The method of claim 1, wherein the step of allocating the user terminals to frequency band sub-blocks further comprising allocating user terminals within the coverage area of each cell and having similar modulation and coding schemes to the same frequency band sub-block.

6. The method of claim 1, wherein the step of allocating the user terminals to frequency band sub-blocks further comprising detecting power levels of signals received from the user terminals within the coverage area of each cell, and allocating user terminals with similar received power levels to the same frequency band sub-block in order to minimize multiple access interference.

7. The method of claim 1, wherein the step of allocating the user terminals to frequency band sub-blocks further comprising detecting power levels of signals received from the user terminals, calculating a radio channel path loss value for each user terminal, and allocating user terminals within the coverage area of each cell and with similar path loss values to the same frequency band sub-block.

8. The method of claim 1, further comprising allocating radio resources according to frequency division multiple access (FDMA) or orthogonal frequency division multiple access (OFDMA) technique to the user terminals that are allocated to the same frequency band sub-block.

9. The method of claim 1, wherein the step of allocating the user terminals to frequency band sub-blocks further comprising allocating user terminals within the coverage area of each cell and having similar modulation and coding schemes to adjacent frequency band sub-blocks.

10. The method of claim 1, wherein the step of controlling transmission power of the user terminals further comprising setting a target for signal-to-noise-power ratio of signals received from the user terminals allocated to the same frequency band sub-block to be the same and controlling the transmission power of the user terminals to achieve a target signal-to-noise-power ratio.

11. The method of claim 1, further comprising detecting which modulation and coding scheme a given user terminal uses, and allocating the given user terminal to a given frequency band sub-block on the basis of the detected modulation and coding scheme.

12. The method of claim 1, further comprising informing a network infrastructure about different combinations of modulation and coding schemes that are used by a given user terminal, and selecting, by the network infrastructure, a given combination of the modulation and coding scheme to be used by the user terminal in a given frequency band sub-block.

13. The method of claim 1, further comprising providing the user terminals with information about which modulation and coding scheme is used in a given frequency band sub-block by a network infrastructure.

14. The method of claim 1, further comprising allocating one or more user terminals to a second frequency band sub-block on the basis of the modulation and coding schemes used by the user terminals when the frequency band sub-block to which the one or more user terminals were first allocated is frequency hopped.

15. The method of claim 14, wherein the second frequency band sub-block uses a modulation and coding scheme similar to those used in the frequency band sub-block to which the one or more user terminals were first allocated.

16. The method of claim 14, further comprising changing the modulation and coding scheme of the one or more user terminals to correspond to a modulation and coding scheme of the second frequency band sub-block before allocating the one or more user terminals to the second frequency band sub-block.

17. The method of claim 1, further comprising separating different frequency band sub-blocks by using digital or analogue filters in the user terminals and in a network infrastructure.

18. A network element of a cellular telecommunication system providing user terminals with communications within the coverage area of the cellular telecommunication system, the coverage area being divided into a plurality of cells, the network element comprising:
a processing unit configured to divide a frequency band of a plurality of cells of the cellular telecommunication system independently into more than one frequency band sub-block, allocate user terminals within the coverage area of each cell to frequency band sub-blocks on the basis of the modulation and coding schemes used by the user terminals, and control transmission power of the user terminals on the basis of the allocation of the user terminals.

19. The network element of claim 18, wherein the processing unit is further configured to divide the frequency band of each of the plurality of cells of the telecommunication system into more than one frequency band sub-block regardless of the frequency band division applied to other cells of the cellular telecommunication system.

20. The network element of claim 18, wherein the processing unit is further configured to allocate user terminals within a coverage area of a plurality of adjacent cells to the frequency band sub-blocks in a similar manner for each cell in order to allocate the user terminals with substantially the same characteristics to the same or adjacent frequency band sub-blocks in the plurality of adjacent cells.

21. The network element of claim 18, wherein the processing unit is further configured to allocate the same frequency band to a plurality of adjacent cells of the cellular telecommunication system.

22. The network element of claim 18, wherein the processing unit is further configured to allocate user terminals within the coverage area of each cell having similar modulation and coding schemes to the same frequency band sub-block.

23. The network element of claim 18, wherein the processing unit is further configured to detect received power levels of signals received from the user terminals, and allocate user terminals within the coverage area of each cell and with similar received power levels to the same frequency band sub-block for minimizing multiple access interference.

24. The network element of claim 18, wherein the processing unit is further configured to detect received power levels of signals received from the user terminals, calculate a radio channel path loss value for each user terminal, and allocate user terminals within the coverage area of each cell and with similar path loss values to the same frequency band sub-block.

25. The network element of claim 18, wherein the processing unit is further configured to allocate radio resources according to frequency division multiple access (FDMA) or orthogonal frequency division multiple access (OF-DMA) technique to the user terminals that are allocated to the same frequency band sub-block.

26. The network element of claim 18, wherein the processing unit is further configured to allocate user terminals within the coverage area of each cell having similar modulation and coding schemes to adjacent frequency band sub-blocks.

27. The network element of claim 18, wherein the processing unit is further configured to set a target for signal-to-noise-power ratio of the signals received from the user terminals allocated to the same frequency band sub-block to be the same and to control the transmission power of the user terminals to achieve a target signal-to-noise-power ratio.

28. The network element of claim 18, wherein the processing unit is further configured to detect which modulation and coding scheme a given user terminal uses and allocate the given user terminal to a given frequency band sub-block on the basis of the detected modulation and coding scheme.

29. The network element of claim 18, wherein the processing unit is further configured to receive information from a user terminal about different combinations of modulation and coding schemes that are used by the user terminal, and to select a given combination of the modulation and coding scheme to be used in a given frequency band sub-block.

30. The network element of claim 18, wherein the processing unit is further configured to provide the user terminals with information about which modulation and coding scheme is used in a given frequency band sub-block.

31. The network element of claim 18, wherein the processing unit is further configured to allocate one or more user terminals to a second frequency band sub-block on the basis of the modulation and coding schemes used by the user terminals when the frequency band sub-block to which the one or more user terminals were first allocated is frequency hopped.

32. The network element of claim 31, wherein the second frequency band sub-block uses modulation and coding scheme similar to those used in the frequency band sub-block to which the one or more user terminals were first allocated.

33. The network element of claim 31, wherein the processing unit is further configured to change the modulation and coding scheme of the one or more user terminals to correspond to the modulation and coding scheme of the second frequency band sub-block before allocating the one or more user terminals to the second frequency band sub-block.

34. The network element of claim 18, wherein the network element further comprises digital or analogue filters for separating the different frequency band sub-blocks.

35. A network element of a cellular telecommunication system providing user terminals with communications within the coverage area of the cellular telecommunication system, the coverage area being divided into a plurality of cells, the network element comprising:
means for dividing a frequency band of a plurality of cells of the cellular telecommunication system independently into more than one frequency band sub-block;
means for allocating user terminals within the coverage area of each cell to frequency band sub-blocks on the basis of the modulation and coding schemes used by the user terminals; and
means for controlling transmission power of the user terminals on the basis of the allocation of the user terminals.

36. A cellular telecommunication system comprising a network infrastructure providing communications within the coverage area of the cellular telecommunication system with the coverage area being divided into a plurality of cells, and a plurality of user terminals located within the coverage area of the cellular telecommunication system, the network infrastructure comprising a processing unit configured to divide a frequency band of a plurality of cells of the cellular telecommunication system independently into more than one frequency band sub-block, allocate user terminals within the coverage area of each cell to frequency band sub-blocks on the basis of the modulation and coding schemes used by the user terminals and to control transmission power of the user terminals on the basis of the allocation of the user terminals.

37. A cellular telecommunication system comprising a network infrastructure providing communications within the coverage area of the cellular telecommunication system with the coverage area being divided into a plurality of cells, and a plurality of user terminals located within the coverage area of the cellular telecommunication system, the network infrastructure comprising:
means for dividing a frequency band of a plurality of cells of the cellular telecommunication system independently into more than one frequency band sub-block;
means for allocating user terminals within the coverage area of each cell to frequency band sub-blocks on the basis of the modulation and coding schemes used by the user terminals; and
means for controlling transmission power of the user terminals on the basis of the allocation of the user terminals.

38. A computer program product embodied on a computer readable medium, the computer program product encoding a computer program of instructions for executing a computer process for radio resource allocation in a cellular telecommunication system, the process comprising:
dividing a frequency band of a plurality of cells of the telecommunication system independently into more than one frequency band sub-block;
allocating user terminals within the coverage area of each cell to frequency band sub-blocks on the basis of the modulation and coding schemes used by the user terminals; and
controlling transmission power of the user terminals on the basis of the allocation of the user terminals.

39. A computer program distribution medium embodied on a computer readable medium and encoding a computer program of instructions for executing a computer process for radio resource allocation in a cellular telecommunication system, the process comprising:
dividing a frequency band of a plurality of cells of the telecommunication system independently into more than one frequency band sub-block;
allocating user terminals within the coverage area of each cell to frequency band sub-blocks on the basis of the modulation and coding schemes used by the user terminals; and
controlling transmission power of the user terminals on the basis of the allocation of the user terminals.

40. The computer program distribution medium of claim 39, wherein the distribution medium comprises at least one of a program storage medium, a record medium, a computer readable memory, a computer readable software distribution package, a computer readable signal, a computer readable telecommunications signal, and a computer readable compressed software package.
